(19) United States
(12) Patent Application Publication
(10) Pub. No.: US 2025/0095365 A1
(43) Pub. Date: Mar. 20, 2025

(54) REAL-TIME ULTRASONIC NODULE DETECTION METHOD, SYSTEM AND DEVICE AND STORAGE MEDIUM

(71) Applicant: TenD.AI Medical Technology (Shanghai) Co., Ltd., Shanghai (CN)

(72) Inventor: Xupeng WANG, Shanghai (CN)

(21) Appl. No.: 18/782,821

(22) Filed: Jul. 24, 2024

(30) Foreign Application Priority Data
Sep. 20, 2023 (CN) 202311219398.3

(51) Int. Cl. G06V 20/40; G06V 10/77; G06V 10/82

(52) U.S. Cl. CPC G06V 20/46; G06V 10/7715; G06V 10/82; G06V 2201/03

(57) ABSTRACT

A real-time ultrasonic nodule detection method, system, device and a storage medium are provided, which relate to the field of ultrasonic detection. The method includes: acquiring video stream data for ultrasonic detection; performing video frame extraction on the video stream data to obtain fast frame data and slow frame data; using real-time detection network for detecting according to the fast frame data and the slow frame data to obtain a real-time nodule prediction box and a nodule confidence level. The solution can meet the demand for real-time detection in the ultrasonic clinical use while improving the accuracy of detecting nodules.

### CROSS-REFERENCE TO RELATED APPLICATIONS

This patent application claims the benefit and priority of Chinese Patent Application No. 202311219398.3 filed with the China National Intellectual Property Administration on Sep. 20, 2023, the disclosure of which is incorporated by reference herein in its entirety as part of the present application.

### TECHNICAL FIELD

The present technology relates to the field of ultrasonic detection, and in particular to a real-time ultrasonic nodule detection method, system, device and a storage medium.

### BACKGROUND

Ultrasonic nodule examination is a most common physical examination method in clinic practice, which involves most organs of a human body (thyroid, breast, liver, heart, kidney, gallbladder, etc.). With the continuous development of an AI technology, the computer vision-aided detection technology can greatly improve the clinical detection effect. At present, the technology based on deep learning can automatically detect ultrasonic images, prompt suspicious nodule areas for doctors, and can save a large amount of energy of doctors for daily physical examination.

In the prior art, most of the target detection technologies carry out learning based on a single-frame static image. In the actual ultrasonic image scanning, doctors capture a moving relationship between images through the moving ultrasonic image features, so as to determine the exact position and shape of nodules. If nodules are determined from a single image, it will inevitably lead to the risk of a large number of false positives and false negatives, which will affect the accuracy of detection.

In the current video detection algorithm using multi-frame dynamic data, it is necessary to process the complete offline video to give the detection result. The algorithm is very complex, and it takes a long time to carry out calculation, which cannot meet the actual demands of doctors in the process of scanning and detection in real time.

### SUMMARY

The present disclosure aims to provide a real-time ultrasonic nodule detection method, system, device and a storage medium, which can meet the demand for real-time detection in the ultrasonic clinical use while improving the accuracy of detecting nodules.

In order to achieve the above objectives, the present disclosure provides the following scheme.

A real-time ultrasonic nodule detection method is provided, including:
acquiring video stream data for ultrasonic detection;
performing video frame extraction on the video stream data to obtain fast frame data and slow frame data;
using real-time detection network for detecting according to the fast frame data and the slow frame data to obtain a real-time nodule prediction box and a nodule confidence level.

In some embodiments, the performing video frame extraction on the video stream data to obtain fast frame data and slow frame data includes:
performing the video frame extraction on the video stream data according to different step sizes based on inter-frame information to obtain the fast frame data and the slow frame data.

In some embodiments, the using real-time detection network for detection according to the fast frame data and the slow frame data to obtain a real-time nodule prediction box and a nodule confidence level includes:
inputting the fast frame data and the slow frame data into a fast and slow frame feature extracting module of the real-time detection network to obtain a fusion feature map;
inputting the fusion feature map into a backbone network of the real-time detection network to obtain three first feature maps corresponding to different scales;
inputting the three first feature maps corresponding to different scales into a feature processing module of the real-time detection network to obtain three second feature maps corresponding to three scales;
inputting the three second feature maps corresponding to three scales into a detecting module of the real-time detection network to obtain the real-time nodule prediction box and the nodule confidence level.

In some embodiments, a network structure of the backbone network is a Squeeze-and-Excitation Module (SE module) and the backbone network of You Only Look Once, version 5 (YOLOv5) connected with the SE module; and the SE module includes a global pooling layer, a channel convolution layer and an attention weighting layer which are connected in sequence.

In some embodiments, a training process of the real-time detection network includes:
with labeled fast frame data and labeled slow frame data as neural network input, with a historical nodule prediction box and a historical nodule confidence level as neural network output, with a sum of a prediction box loss function, a classification loss function and a confidence level loss function as a total loss function, optimizing parameters of the neural network by using a Stochastic Gradient Descent (SGD) optimizer and using a learning rate of dynamic cosine attenuation, to obtain the real-time detection network.

In some embodiments, the prediction box loss function is a Complete Intersection over Union (CIOU) loss function; and both the classification loss function and the confidence level loss function use binary cross entropy.

The present disclosure further provides a real-time ultrasonic nodule detection system, including:
an acquiring module, which is configured to acquire video stream data for ultrasonic detection;
a video frame extracting module, which is configured to perform video frame extraction on the video stream data to obtain fast frame data and slow frame data;
a detecting module, which is configured to use real-time detection network for detecting according to the fast frame data and the slow frame data to obtain a real-time nodule prediction box and a nodule confidence level.

In some embodiments, the video frame extracting module specifically includes:
a video frame extracting unit, which is configured to perform video frame extraction on the video stream data according to different step sizes based on inter-frame information to obtain the fast frame data and the slow frame data.

The present disclosure further provides an electronic device, including:
one or more processors;
a storage device on which one or more programs are stored;
where the one or more programs, when executed by the one or more processors, cause the one or more processors to implement the real-time ultrasonic nodule detection method described above.

The present disclosure further provides a non-transitory computer storage medium having a computer program stored thereon, where the computer program, when executed by a processor, implements the real-time ultrasonic nodule detection method described above.

According to the specific embodiment provided by the present disclosure, the present disclosure provides the following technical effects.

The present disclosure acquires video stream data for ultrasonic detection;
performs video frame extraction on the video stream data to obtain fast frame data and slow frame data; uses real-time detection network for detection according to the fast frame data and the slow frame data to obtain a real-time nodule prediction box and a nodule confidence level. Based on the dynamic features of the ultrasonic image, compared with a detection algorithm of an original single-frame analysis static image, the present disclosure makes more reasonable use of the dynamic features of the ultrasonic image for detection, and greatly improves the detection accuracy. In the use of the dynamic features of the ultrasonic image, the fast and slow states of ultrasonic scanning are decomposed in a manner of simulating human visual perception. The fast video stream can capture the dynamic relationship of video streams better, while the slow video stream can perceive the spatial relationship at the pixel level better. By fusing the two features, it is possible to simulate human-like visual understanding of a dynamic video better, and enhance the ability to determine whether it is a lesion in the dynamic real-time scanning process, so as to meet the demand for real-time detection in the ultrasonic clinical use while improving the accuracy of detecting nodules.

### BRIEF DESCRIPTION OF THE DRAWINGS

In order to illustrate the embodiments of the present disclosure or the technical schemes in the prior art more clearly, the drawings that need to be used in the embodiments will be briefly introduced. Obviously, the drawings in the following description are only some embodiments of the present disclosure. For those skilled in the art, other drawings can be acquired according to these drawings without creative labor.

FIG. 1A and FIG. 1B are pictures showing a processing on fast and slow frame data of a video stream.

FIG. 2 is an image frame with training data being labelled.

FIG. 3 is a schematic diagram of an architecture of a real-time detection network.

FIG. 4 is a schematic diagram of an architecture of a backbone network.

FIG. 5 is a schematic diagram of an architecture of a feature processing module.

FIG. 6 is an overall flow chart of a real-time ultrasonic nodule detection method.

FIG. 7 is a flowchart of a real-time ultrasonic nodule detection method according to the present disclosure.

### DETAILED DESCRIPTION OF THE EMBODIMENTS

The technical schemes in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiment of the present disclosure, all other embodiments acquired by those skilled in the art without creative labor fall within the scope of protection of the present disclosure.

The present disclosure aims to provide a real-time ultrasonic nodule detection method, system, and device, and a storage medium, which can meet the demand for real-time detection in the ultrasonic clinical use while improving the accuracy of detecting nodules.

In order to make the above objects, features and advantages of the present disclosure more clear and understandable, the present disclosure will be explained in further detail with reference to the drawings and detailed description hereinafter.

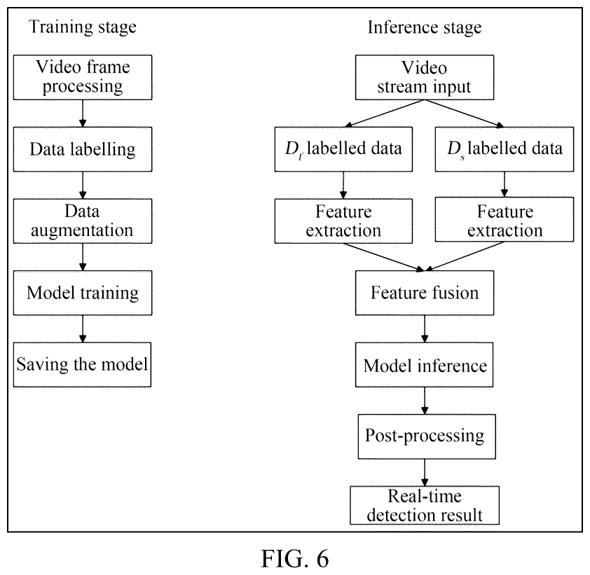

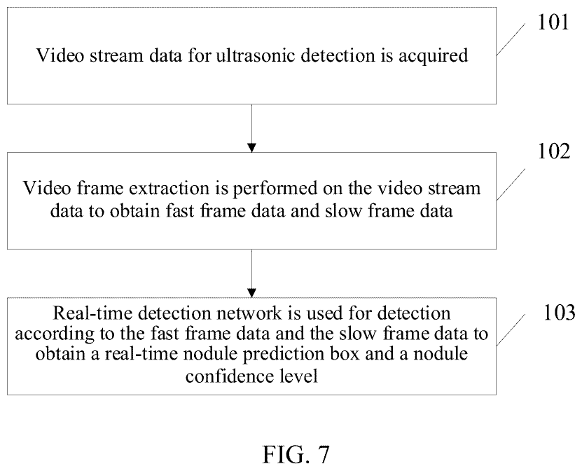

As shown in FIGS. 6 and 7, a real-time ultrasonic nodule detection method according to the present disclosure includes the following steps 101-103.

In step 101: video stream data for ultrasonic detection is acquired.

Video stream data processing is performed. Specifically, the data of the present disclosure is acquired using a professional-grade acquisition card device which can support various video resolution formats, having high bandwidth transmission capability. Continuous high-definition video stream data acquired from an ultrasonic device is collected. In order to reduce transmission delay, the video stream data is compressed by H.265 coding, and the compressed data is decoded before being input into the image detection algorithm, so as to restore to the original video stream data. In this way, the real-time performance and the stability of acquiring data are ensured.

In step 102: video frame extraction is performed on the video stream data to obtain fast frame data and slow frame data.

In step 102, performing video frame extraction on the video stream data to obtain fast frame data and slow frame data specifically includes: performing video frame extraction on the video stream data according to different step sizes based on inter-frame information to obtain fast frame data and slow frame data.

Video frame processing is performed. Specifically, since features of lesions and tissues in ultrasound detection are characterized by dynamic features, it is easy to result in false positives and false negatives by analyzing lesions only through a single frame static image. In this method, the video stream is detected by combining the inter-frame information, and the dynamic video stream is divided into a faster video stream and a slower video stream in a manner of simulating human visual perception, where the faster video stream captures the dynamic relationship between the dynamic frames, and the slower video stream captures the mutual relationship of various parts of the image. By fusing the two features of the video streams, it is possible to simulate human-like understanding of the dynamic relationship in the video better.

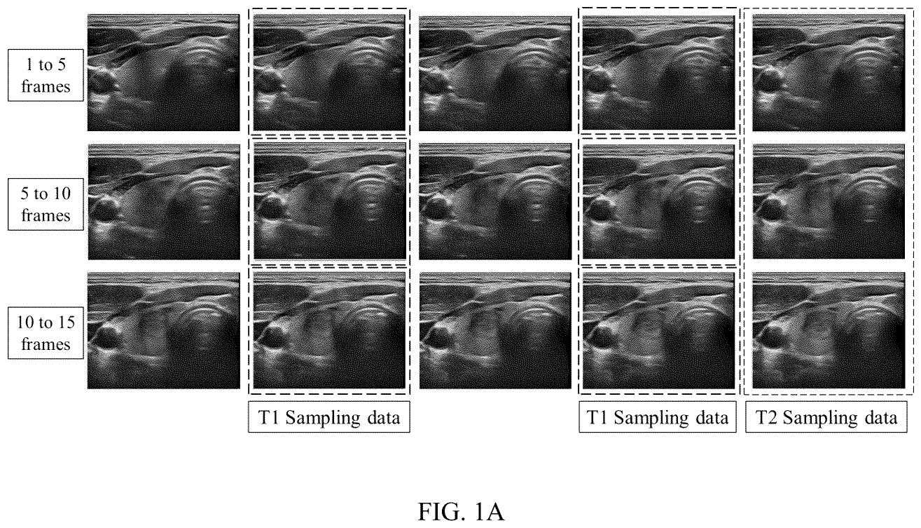

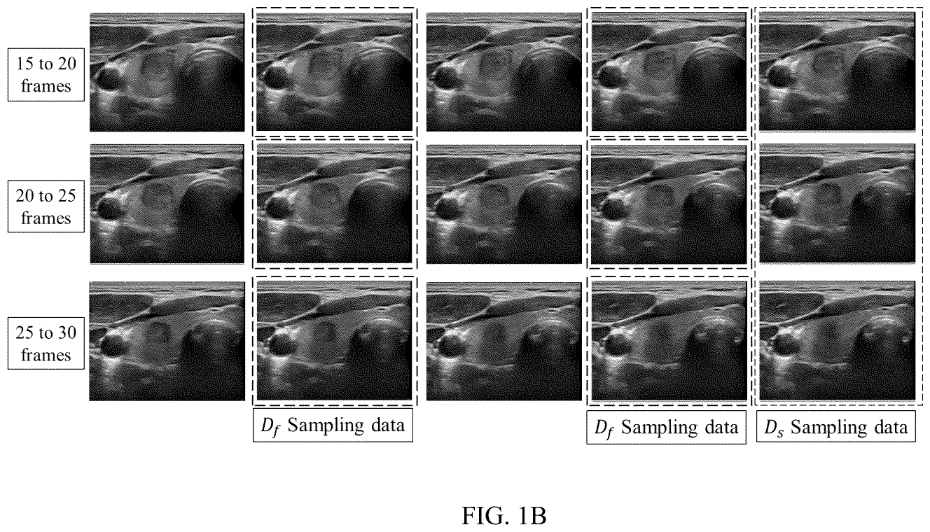

Further, the video stream processing method is as follows. For the target detection network, the video stream data obtained by the acquisition card is processed in groups of 30 frames, the video frames are extracted at a step size of 2 frames and saved as fast frame data D_{f}, and the video frames are extracted at a step size of 5 frames and saved as slow frame data Dₛ, where the saved D_{f} and Dₛ are used as training data. In the detection stage, in the video stream output by the acquisition card, 15 frames of 30 frames of data are intercepted forward at a step size of 2 frames as fast frame input, and 6 frames of 30 frames of data are intercepted forward at a step size of 5 frames as slow frame input. At the current frame, two sets of data for the previous 30 frames are simultaneously input to the network for detecting. The two data processing methods both process 30 frames of video, which are shown in FIG. 1A and FIG. 1B.

In step 103: real-time detection network is used for detecting according to the fast frame data and the slow frame data to obtain a real-time nodule prediction box and a nodule confidence level.

The step 103 specifically includes:
inputting the fast frame data and the slow frame data into a fast and slow frame feature extracting module of the real-time detection network to obtain a fusion feature map; inputting the fusion feature map into a backbone network of the real-time detection network to obtain three first feature maps corresponding to different scales, where a network structure of the backbone network is a Squeeze-and-Excitation Module (SE module) and the backbone network of YOLOv5 connected with the SE module, and the SE module includes a global pooling layer, a channel convolution layer and an attention weighting layer which are connected in sequence; inputting three first feature maps corresponding to three different scales into a feature processing module of the real-time detection network to obtain second feature maps corresponding to three scales; inputting the second feature maps of three scales into a detecting module of the real-time detection network to obtain the real-time nodule prediction box and the nodule confidence level.

A training process of the real-time detection network includes:
taking labeled fast frame data and labeled slow frame data as neural network input, taking a historical nodule prediction box and a historical nodule confidence level as neural network output, taking the sum of a prediction box loss function, a classification loss function and a confidence level loss function as a total loss function, optimizing parameters of the neural network by using a Stochastic Gradient Descent (SGD) optimizer and using a learning rate of dynamic cosine attenuation, to obtain a real-time detection network.

The prediction box loss function is a Complete Intersection over Union (CIOU) loss function; and both the classification loss function and the confidence level loss function use binary cross entropy.

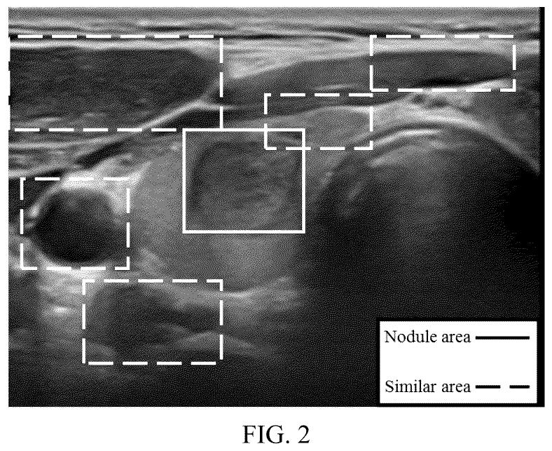

Data labelling is performed. Specifically, for the data D_{f} and Dₛ to be learned, the lesions and similar tissues are labeled by manually labelling candidate boxes, where the lesion area is the complete boundary of the nodules, and the similar areas include but are not limited to approximate areas such as fat blocks, blood vessels, ducts and artifacts. The labelling result is stored in a tag text through (xx, yy, ww, hh), where xx is the abscissa at the upper left corner of the candidate box, yy is the ordinate at the upper left corner of the candidate box, ww is the width of the candidate box, and hh is the height of the candidate box. The labelling method is shown in FIG. 2.

Model training is performed. Specifically, the data D_{f} and Dₛ are trained by the real-time detection network YOLOFS of the present disclosure, and a network which can be used for ultrasonic detection of thyroid nodules is obtained.

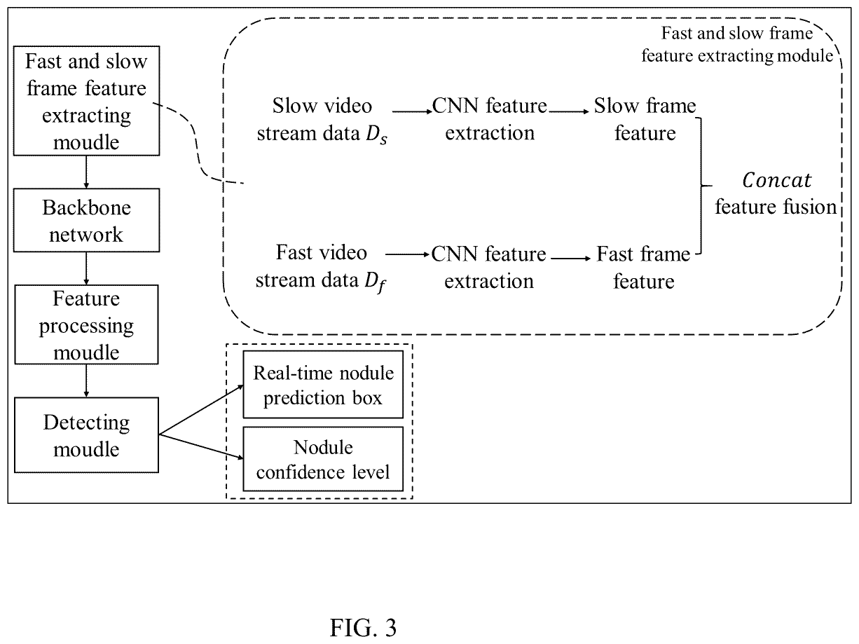

Further, the main structure of the real-time detection network YOLOFS includes: 1. a fast and slow frame feature extracting module, 2. a backbone network, 3. a feature processing module and 4. a detecting module. The architecture of the real-time detection network is shown in FIG. 3.

1. The fast and slow frame feature extracting module is described now. In the real-time detection stage, the current image frame is set as Dₜ, a 6 image frames are intercepted forward at a step size of 5 as the slow frame data stream Dₛ; and a 15 image frames are intercepted forward at a step size of 2 as the fast frame data stream D_{f}. Each currently predicted frame image has the previous 30 frames as a detection input unit. The fast and slow frame feature extracting module extracts image features through the convolutional neural network (CNN), and then carries out Concat feature fusion on the obtained slow frame features and fast frame features.

Further, the specific structure of the CNN convolution network of the fast and slow frame feature extracting module of the present disclosure is as follows.

Fast frame: a first layer uses a 3×3 convolution kernel with a step size of 1 and 20 channels; a second layer uses a 2×2 convolution kernel, and a pooling layer with a step size of 2, which uses a maximum pooling method; a third layer uses a batch normalization (BN) layer to normalize the pooled feature map, so as to have a zero mean and a unit variance, which is beneficial to improve the training speed and the stability. A fourth layer uses a 1×1 convolution kernel with a step size of 1 and 40 channels. The input data size of the fast frame is 512×512×12, and the output size of the feature map is 256×256×40.

Slow frame: a first layer uses a 3×3 convolution kernel with a step size of 1 and 12 channels; a second layer uses a 2×2 convolution kernel, and a pooling layer with a step size of 2, which uses a maximum pooling method; a third layer uses a batch normalization BN layer to normalize the pooled feature map. A fourth layer uses a 1×1 convolution kernel with a step size of 1 and 24 channels. The input data size of the slow frame is 512×512×6, and the output size of the feature map is 256×256×24.

Concat feature fusion is carried out on the feature maps of fast frames and slow frames to obtain the output feature map with the size of 256×256×64.

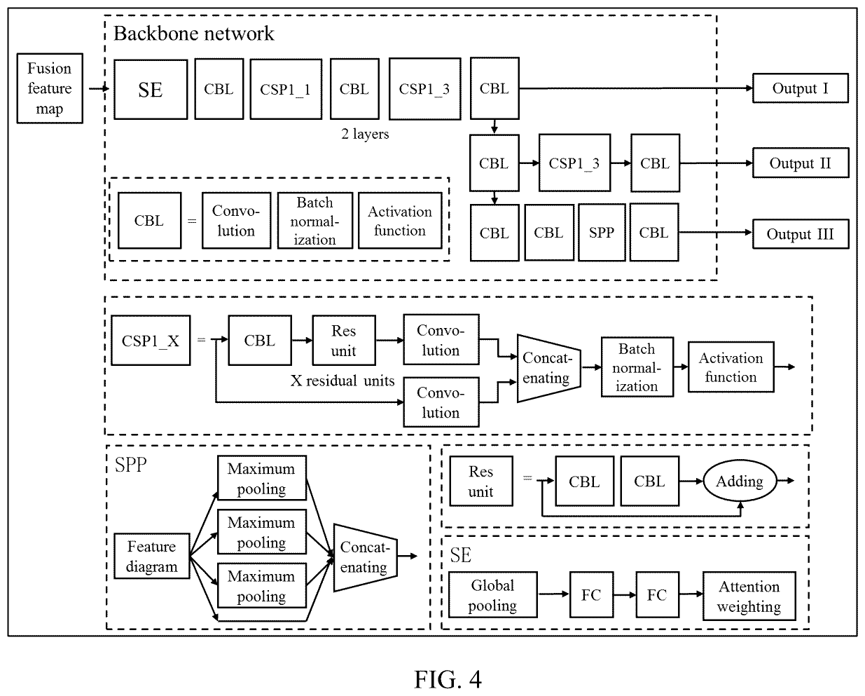

2. The backbone network is described now. The backbone network includes Squeeze-and-Excitation (SE), Conv+Bn+Leaky_relu (CBL), CSPNet (CSP1) and Spatial Pyramid Pooling (SPP) modules. Preferably, the backbone network is consists of SE, CBL, CSP1 and SPP modules. The architecture diagram is shown in FIG. 4, which is an improvement to the backbone network of the existing YOLOv5 framework and is added into the SE module. The input is a fusion feature map with a size of 256×256×64 which is extracted by the fast and slow frame extracting module in 1. The output is a feature map of three scales.

In order to increase the correlation between the fused feature map channels, an SE attention module is added. The size of the input feature map is 256×256×64. The SE attention module first performs global average pooling on each channel to obtain a feature map of 1×1×64. Thereafter, the correlation between channels is constructed by two fully connected (FC) layers. Finally, attention weighting is realized by channel multiplication, and the weighted feature map with the same size as the original size is obtained. The SE module allows the model to pay more attention to the channel features with the largest amount of information, while suppressing the channel features with lower correlation, so that the information between fast and slow frame channels can be transmitted more accurately.

A CBL layer extracts features by a convolution layer, a batch normalization BN layer, and a LekyRelu activation layer.

The CSP1 layer includes a CBL, a residual unit (Res unit), a convolution layer, a batch normalization layer BN and an activation function layer. Preferredly, the CSP1 layer is consists of a CBL, a residual unit (Res unit), a convolution layer, a batch normalization layer BN and an activation function layer. The CSP1 can better extract image features and accelerate network convergence.

The SPP is a multi-scale feature fusion module, which aggregates feature maps of three scales (large, medium and small) through three maximal pooling layers. Shallow feature maps have rich detailed features, and deep feature maps have rich semantic features. Fusion of shallow and deep features can aggregate multi-scale feature information to enhance the feature learning capability.

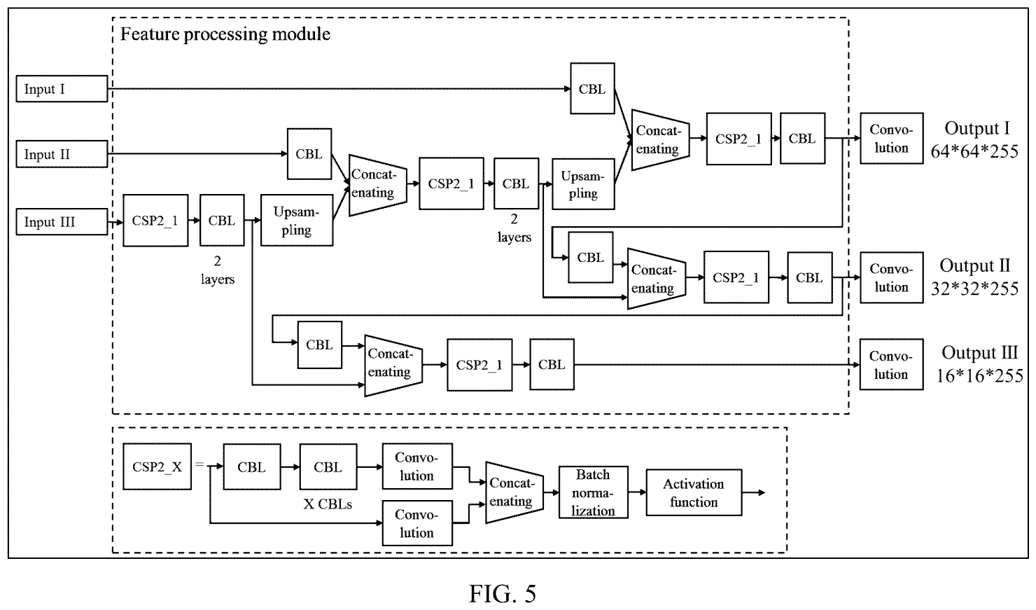

3. The feature processing module is described now. The purpose of the module is to further learn the feature map in the backbone network and increase the attention to the targets of three scales, namely large, medium and small. The feature processing module is a Neck part of the existing network YOLOv5. The inputs are feature maps corresponding to three scales output in the previous stage. The input I corresponds to a feature map of output I (large), the input II corresponds to the output II (middle), and the input III corresponds to the output III (small). The outputs are also feature maps corresponding to three scales. The network calculation as a whole is a process of feature maps from a large size to a small size. The original input size is 512×512×(12+6). The feature vectors of (16128, 11) obtained by concatenating and aggregating the output feature maps of three scales participate in the loss calculation of classification and bounding box regression. The architecture diagram of the module is shown in FIG. 5.

A CBL layer extracts features by a convolution layer, a batch normalization BN layer, and a LekyRelu activation layer.

The CSP2 layer includes a plurality of CBLs, a convolution layer, a batch normalization layer BN and an activation function layer. Preferably, the CSP2 layer is consists of a plurality of CBLs, a convolution layer, a batch normalization layer BN and an activation function layer. The CSP2 can better extract image features and accelerate network convergence.

Feature Pyramid Networks (FPN)+Path Aggregation Network (PAN) module is described now. Since the shallow feature map is more sensitive to the detailed texture features, and the deep feature map has a wider receptive field, the fusion method of feature pyramids can combine the shallow and deep information of the network to enhance the feature extraction capability. FPN performs fusion through a top-down feature pyramid, which conveys more semantic information, while PAN performs fusion through a bottom-up feature pyramid, which conveys more positioning information. The manner of FPN+PAN can capture targets of different scales. After Neck processing, the three output feature maps have the dimensions of (64, 64, 255), (32, 32, 255) and (16, 16, 255), respectively, which will be used as the input of a prediction head.

4. The detecting module is described now. The detecting module concatenates the input three feature maps, and the result of concatenation and aggregation is a set of feature vectors of (16128, 11), where 11 represents (x, y, w, h, cls)+6 categories of confidence levels to participate in the loss calculation. The output result includes (a bounding box x, a bounding box y, a bounding box width, a bounding box height, a target probability)+probabilities of 6 categories. The feature maps are aggregated into a feature vector with the dimension of (16128, 11) to calculate the loss. The loss function is:

$${L}_{total} = {L}_{onj} + {L}_{cls} + {L}_{conf}$$

where Lₜₒₜₐₗ is a total loss, L_{obj} is a prediction box loss, L_{cis} is a classification loss, and L_{conf} is a confidence level loss.

L_{obj} is the predict box loss which uses a Complete Intersection over Union (CIOU) loss function. Compared with the traditional Intersection over Union (IOU), the CIOU considers the factors of an overlapping area, a distance between centers and an aspect ratio. The calculation formula is as follows:

$${L}_{obj} = 1 - ( IOU - \frac{{p}^{2} ( b , {b}^{gt} )}{{c}^{2}} - av )$$

The calculation formula of the IOU is:

$$IOU = \frac{intersection of a prediction box and a true box}{union of a prediction box and a true box}$$

where p²(b, b^{gt}) denotes an Euclidean distance between a center of the prediction box b and a center of the true box b^{gt}. c denotes a diagonal distance of a minimum bounding rectangle of the union between the prediction box and the true box.
where α is a factor of the aspect ratio, and its formula is:

$$α = \frac{v}{1 - IOU + v}$$

where v is a parameter to measure the consistency of the aspect ratio, and its formula is:

$$v = \frac{4}{{π}^{2}} ( {tan}^{- 1} \frac{{w}^{gt}}{{h}^{gt}} - {tan}^{- 1} \frac{w}{h} )$$

where w, h, w^{gt} and h^{gt} denote the width and the height of the prediction box and the width and the height of the true box, respectively.

A regression mode of CIOU Loss allows the prediction box to be more accurate.

The classification loss function L_{cls} and the confidence level loss function L_{conf} use binary cross entropy instead of softmax function, which reduces the calculation complexity. The formula is as follows:

$$L = - y log p - ( 1 - y ) log ( 1 - p ) = \{ \begin{matrix}- log p , & y = 1 \\ - log ( 1 - p ) , & y = 0\end{matrix}$$

where y is a label corresponding to the input sample, a positive sample is 1, a negative sample is 0, and p is the probability that the model predicts that the input is a positive sample. L is a loss function.

The labelled Dₛ and D_{f} data are fed to the network. A Stochastic Gradient Descent (SGD) optimizer is used, a learning rate of dynamic cosine attenuation is used, an initial learning rate is set to 0.0001, a detection threshold is set to 0.5, a Non-Maximum Suppression (NMS) threshold is set to 0.25, a batch size is set to 16, and the maximum number of training epochs is set to 1000. The training process terminates when the total loss Lₜₒₜₐₗ of the model does not decrease in 50 consecutive epochs, or when the maximum number of training epochs is reached.

Real-time detection is described now. In practical use, the results can be output in real time by reading the real-time video stream (non-local video), and the detection results are framed in the original image.

Specifically, in the real-time detection stage, a 6 image frames are intercepted forward at a step size of 5 as the slow frame data stream Dₛ; and a 15 image frames are intercepted forward at a step size of 2 as the fast frame data stream D_{f}. For each currently predicted image frame, the previous 30 frames are deemed as a detection input unit. Each detection input unit is passed through the trained model, to obtain the detection result of each frame.

Specifically, the trained model is used for detection. Real-time high-definition data of an ultrasonic machine is obtained in a manner of encoding and decoding, by using an ultrasonic acquisition card, with a speed kept at 30 fps. At this time, with the step size of 2 as D_{f} input and taking the step size of 5 as Dₛ input, the network outputs two sets of feature vectors. The feature vectors are concatenated, and the predicted bounding box and classification results are obtained every 30 frames through the feature vectors.

The present disclosure further provides a real-time ultrasonic nodule detection system, including:
an acquiring module, which is configured to acquire video stream data for ultrasonic detection;
a video frame extracting module, which is configured to perform video frame extraction on the video stream data to obtain fast frame data and slow frame data;
a detecting module, which is configured to use real-time detection network for detecting according to the fast frame data and the slow frame data to obtain a real-time nodule prediction box and a nodule confidence level.

As an embodiment, the video frame extracting module includes:
a video frame extracting unit, which is configured to perform video frame extraction on the video stream data according to different step sizes based on inter-frame information to obtain the fast frame data and the slow frame data.

The present disclosure further provides an electronic device, including: one or more processors; a storage device on which one or more programs are stored; where the one or more programs, when executed by the one or more processors, cause the one or more processors to implement the real-time ultrasonic nodule detection method described above.

The present disclosure further provides a non-transitory computer storage medium having a computer program stored thereon, where the computer program, when executed by a processor, implements the real-time ultrasonic nodule detection method described above.

The present disclosure provides a real-time ultrasonic nodule detection method based on fast and slow frames, which makes full use of the relationship between real-time dynamic features of the ultrasonic image, and meets the demand for real-time detection in the ultrasonic clinical use while improving the accuracy of detecting nodules. Based on the dynamic features of the ultrasonic image, the present disclosure designs a real-time ultrasonic nodule detection method for dynamic features. Compared with a detection algorithm of an original single-frame analysis static image, the present disclosure makes more reasonable use of the dynamic features of the ultrasonic image for detection, and greatly improves the detection accuracy.

In the use of the dynamic features of the ultrasonic image, the fast and slow states of ultrasonic scanning are decomposed in a manner of simulating human visual perception. The fast video stream can capture the dynamic relationship of video streams better, while the slow video stream can perceive the spatial relationship at the pixel level better. By fusing the two features, it is possible to simulate human-like visual understanding of a dynamic video better, and enhance the ability to determine whether it is a lesion in the dynamic real-time scanning process.

The network used in the present disclosure uses an end-to-end training and detection method, and does not need multiple deployments, thus reducing the complexity of implementing models while maintaining the real-time requirement of the original target detection network.

While maintaining the high sensitivity of a target detection task, the present disclosure improves the defect of nodule detection false positives resulted from high similarity of static features, reduces the problems of false negatives and false positives in real-time nodule detection, and improves the accuracy and efficiency of AI-assisted diagnosis.

In this specification, various embodiments are described in a progressive way. The differences between each embodiment and other embodiments are highlighted, and the same and similar parts of various embodiments can be referred to each other. Since the system provided in the embodiment corresponds to the method provided in the embodiment, the device is described simply. Refer to the description of the method for the relevant points.

In the present disclosure, specific examples are applied to illustrate the principle and implementation of the present disclosure, and the explanations of the above embodiments are only used to help understand the method and core ideas of the present disclosure. At the same time, according to the idea of the present disclosure, there will be some changes in the specific implementation and application scope for those skilled in the art. To sum up, the contents of the specification should not be construed as limiting the present disclosure.

What is claimed is:

1. A real-time ultrasonic nodule detection method, comprising:
acquiring video stream data for ultrasonic detection;
performing video frame extraction on the video stream data to obtain fast frame data and slow frame data;
using real-time detection network for detecting according to the fast frame data and the slow frame data to obtain a real-time nodule prediction box and a nodule confidence level.

2. The real-time ultrasonic nodule detection method according to claim 1, wherein the performing video frame extraction on the video stream data to obtain fast frame data and slow frame data comprises:
performing the video frame extraction on the video stream data according to different step sizes based on inter-frame information to obtain the fast frame data and the slow frame data.

3. The real-time ultrasonic nodule detection method according to claim 1, wherein the using real-time detection network for detection according to the fast frame data and the slow frame data to obtain a real-time nodule prediction box and a nodule confidence level comprises:
inputting the fast frame data and the slow frame data into a fast and slow frame feature extracting module of the real-time detection network to obtain a fusion feature map;
inputting the fusion feature map into a backbone network of the real-time detection network to obtain three first feature maps corresponding to different scales;
inputting the three first feature maps corresponding to different scales into a feature processing module of the real-time detection network to obtain three second feature maps corresponding to three scales;
inputting the three second feature maps corresponding to three scales into a detecting module of the real-time detection network to obtain the real-time nodule prediction box and the nodule confidence level.

4. The real-time ultrasonic nodule detection method according to claim 3, wherein a network structure of the backbone network is a Squeeze-and-Excitation Module (SE module) and the backbone network of You Only Look Once, version 5 (YOLOv5) connected with the SE module; and the SE module comprises a global pooling layer, a channel convolution layer and an attention weighting layer which are connected in sequence.

5. The real-time ultrasonic nodule detection method according to claim 1, wherein a training process of the real-time detection network comprises:
with labeled fast frame data and labeled slow frame data as neural network input, with a historical nodule prediction box and a historical nodule confidence level as neural network output, with a sum of a prediction box loss function, a classification loss function and a confidence level loss function as a total loss function, optimizing parameters of the neural network by using a Stochastic Gradient Descent (SGD) optimizer and using a learning rate of dynamic cosine attenuation, to obtain the real-time detection network.

6. The real-time ultrasonic nodule detection method according to claim 5, wherein the prediction box loss function is a Complete Intersection over Union (CIOU) loss function; and both the classification loss function and the confidence level loss function use binary cross entropy.

7. A real-time ultrasonic nodule detection system, comprising:
an acquiring module, which is configured to acquire video stream data for ultrasonic detection;
a video frame extracting module, which is configured to perform video frame extraction on the video stream data to obtain fast frame data and slow frame data;
a detecting module, which is configured to use real-time detection network for detecting according to the fast frame data and the slow frame data to obtain a real-time nodule prediction box and a nodule confidence level.

8. The real-time ultrasonic nodule detection system according to claim 7, wherein the video frame extracting module comprises:
a video frame extracting unit, which is configured to perform video frame extraction on the video stream data according to different step sizes based on inter-frame information to obtain the fast frame data and the slow frame data.

9. An electronic device, comprising:
one or more processors;
a storage device on which one or more programs are stored;
wherein the one or more programs, when executed by the one or more processors, cause the one or more processors to implement the real-time ultrasonic nodule detection method according to claim 1.

10. The electronic device according to claim 9, wherein the performing video frame extraction on the video stream data to obtain fast frame data and slow frame data comprises:
performing the video frame extraction on the video stream data according to different step sizes based on inter-frame information to obtain the fast frame data and the slow frame data.

11. The electronic device according to claim 9, wherein the using real-time detection network for detection according to the fast frame data and the slow frame data to obtain a real-time nodule prediction box and a nodule confidence level comprises:
inputting the fast frame data and the slow frame data into a fast and slow frame feature extracting module of the real-time detection network to obtain a fusion feature map;
inputting the fusion feature map into a backbone network of the real-time detection network to obtain three first feature maps corresponding to different scales;
inputting the three first feature maps corresponding to different scales into a feature processing module of the real-time detection network to obtain three second feature maps corresponding to three scales;
inputting the three second feature maps corresponding to three scales into a detecting module of the real-time detection network to obtain the real-time nodule prediction box and the nodule confidence level.

12. The electronic device according to claim 11, wherein a network structure of the backbone network is a Squeeze-and-Excitation Module (SE module) and the backbone network of You Only Look Once, version 5 (YOLOv5) connected with the SE module; and the SE module comprises a global pooling layer, a channel convolution layer and an attention weighting layer which are connected in sequence.

13. The electronic device according to claim 9, wherein a training process of the real-time detection network comprises:
with labeled fast frame data and labeled slow frame data as neural network input, with a historical nodule prediction box and a historical nodule confidence level as neural network output, with a sum of a prediction box loss function, a classification loss function and a confidence level loss function as a total loss function, optimizing parameters of the neural network by using a Stochastic Gradient Descent (SGD) optimizer and using a learning rate of dynamic cosine attenuation, to obtain the real-time detection network.

14. The electronic device according to claim 13, wherein the prediction box loss function is a Complete Intersection over Union (CIOU) loss function; and both the classification loss function and the confidence level loss function use binary cross entropy.

15. A non-transitory computer storage medium having a computer program stored thereon, wherein the computer program, when executed by a processor, implements the real-time ultrasonic nodule detection method according to claim 1.

16. The non-transitory computer storage medium according to claim 15, wherein the performing video frame extraction on the video stream data to obtain fast frame data and slow frame data comprises:
performing the video frame extraction on the video stream data according to different step sizes based on inter-frame information to obtain the fast frame data and the slow frame data.

17. The non-transitory computer storage medium according to claim 15, wherein the using real-time detection network for detection according to the fast frame data and the slow frame data to obtain a real-time nodule prediction box and a nodule confidence level comprises:
inputting the fast frame data and the slow frame data into a fast and slow frame feature extracting module of the real-time detection network to obtain a fusion feature map;
inputting the fusion feature map into a backbone network of the real-time detection network to obtain three first feature maps corresponding to different scales;
inputting the three first feature maps corresponding to different scales into a feature processing module of the real-time detection network to obtain three second feature maps corresponding to three scales;
inputting the three second feature maps corresponding to three scales into a detecting module of the real-time detection network to obtain the real-time nodule prediction box and the nodule confidence level.

18. The non-transitory computer storage medium according to claim 17, wherein a network structure of the backbone network is a Squeeze-and-Excitation Module (SE module) and the backbone network of You Only Look Once, version 5 (YOLOv5) connected with the SE module; and the SE module comprises a global pooling layer, a channel convolution layer and an attention weighting layer which are connected in sequence.

19. The non-transitory computer storage medium according to claim 15, wherein a training process of the real-time detection network comprises:
with labeled fast frame data and labeled slow frame data as neural network input, with a historical nodule prediction box and a historical nodule confidence level as neural network output, with a sum of a prediction box loss function, a classification loss function and a confidence level loss function as a total loss function, optimizing parameters of the neural network by using a Stochastic Gradient Descent (SGD) optimizer and using a learning rate of dynamic cosine attenuation, to obtain the real-time detection network.

20. The non-transitory computer storage medium according to claim 19, wherein the prediction box loss function is a Complete Intersection over Union (CIOU) loss function; and both the classification loss function and the confidence level loss function use binary cross entropy.
